(19) United States
(12) Patent Application Publication
(10) Pub. No.: US 2017/0366612 A1
(43) Pub. Date: Dec. 21, 2017

(54) PARALLEL PROCESSING DEVICE AND MEMORY CACHE CONTROL METHOD

(71) Applicant: FUJITSU LIMITED, Kawasaki-shi (JP)

(72) Inventors: Masahiko Yamada, Zama (JP); Tsuyoshi HASHIMOTO, Kawasaki (JP)

(73) Assignee: FUJITSU LIMITED, Kawasaki-shi (JP)

(21) Appl. No.: 15/597,550

(22) Filed: May 17, 2017

(30) Foreign Application Priority Data
Jun. 17, 2016 (JP) 2016-121212

(51) Int. Cl. H04L 29/08; G06F 12/0813; H04L 29/06

(52) U.S. Cl. CPC H04L 67/1097; H04L 67/40; H04L 67/42; G06F 12/0813; G06F 2212/154; G06F 2212/60; G06F 2212/62

(57) ABSTRACT

A memory cache control method for a parallel processing device having a plurality of nodes, wherein a first node stores first data as a client cache in a first storage device and switches an use of the stored first data to a server cache; and a second node stores the first data in a second storage device which is slower than the first storage device, records data management information which indicates that the first data is being stored by in the first storage device of the first node, and when a transmission request of the first data is received from a third node, refers to the data management information, and when the first data is stored in the first storage device of the first node and when the first data is switched to the server cache, instructs the first node to transmit the first data to the third node.

### CROSS-REFERENCE TO RELATED APPLICATION

This application is based upon and claims the benefit of priority of the prior Japanese Patent Application No. 2016-121212, filed on Jun. 17, 2016, the entire contents of which are incorporated herein by reference.

### FIELD

The embodiment discussed herein relates to a parallel processing device and a memory cache control method.

### BACKGROUND

When a client accesses a file stored in a file server over a network, a file cache is stored in a main memory of the client. FIG. 22 is a view illustrating a case in which a file cache is stored in a main memory of a client.

In FIG. 22, a file management unit 81 of a file server 8 processes the file access from a client 9 over a network 8c. A client application 91 operating in the client 9 uses a remote procedure call (RPC) protocol to access a file stored in the file server 8.

At this time, the main memory of the client 9 stores a file cache 92 as a primary cache and the client application 91 accesses the file cache 92 thereby accessing the file stored in the file server 8.

If the primary cache is overflowing, a secondary cache is disposed in the cache server. FIG. 23 is a view illustrating the secondary cache disposed in the cache server. As illustrated in FIG. 23, a client cache 93 is disposed as a secondary cache in the main memory of a cache server 9a connected to the network 8c. When writing to the file cache 92 is carried out by the client application 91, the writing is reflected in the client cache 93 and the contents of the client cache 93 are reflected in the file server 8.

In order to increase the speed of the access to the files in the, file server 8, copies of the files are disposed in the cache server as a server cache. FIG. 24 is a view illustrating a server cache disposed in the cache server. As illustrated in FIG. 24, a server cache 82 is disposed in the main memory of the cache server 8a connected to the network 8c. When writing to the file cache 92 is carried out by the client application 91, the writing is reflected in the server cache 82 and the contents of the server cache 82 are reflected in the file server 8.

There is a technique for disposing a suitable cache by acquiring characteristics data indicating access characteristics with regard to data stored in a storage device of a first node, and by determining resources allocated to the cache based in the acquired characteristics data in a system including a plurality of nodes. See, for example Japanese Laid-open Patent Publication No. 2013-205891.

Moreover, there is a technique for improving data acquisition efficiency by storing, as a cache, original data acquired from a data storage unit, and upon receiving a data acquisition request, and limiting the updating of the original data stored by the data storage unit before determining whether the cache can be used. See, for example, Japanese Laid-open Patent Publication No. 2008-146380.

There is also a technique for suppressing a drop in performance by providing a cache storage between a client and a storage when the client and the storage are communicating over a network. See, for example, Japanese Laid-open Patent Publication No. 2004-342071.

When the contents of a file stored in the client cache 93 in a job A are also to be used in a job B in a system that uses a cache server, the contents of the client cache 93 at the time that the job A is finished are written to a disk device of the file server 8. As illustrated in. FIG. 24, the file is then read from the disk device of the file server 8 in the job B and is then used by being read to the main memory of the cache server 8a as the server cache 82.

That is, the contents of the main memory used as the client cache 93 in the job A are written to the disk device and then re-read o the main memory as the server cache 82. As a result, there is a problem that wasteful writing to the disk device and wasteful reading from the disk device occur before executing the job B. In particular, when a series of related jobs are executed in a super computer, files used in a previous job are often used in the next job and wasteful reading and writing occurs often.

An object of one aspect of the embodiment discussed herein is to suppress wasteful reading and writing to a disk device.

### SUMMARY

According to an aspect of the invention, a memory cache control method for a parallel processing device having a plurality of nodes, wherein a first node stores first data as a client cache in a first storage device and switches an use of the stored first data to a server cache; and a second node stores the first data in a second storage device which is slower than the first storage device, records data management information which indicates that the first data is being stored by in the first storage device of the first node, and when a transmission request of the first data is received from a third node, refers to the data management information, and when the first data is stored in the first storage device of the first node and when the first data is switched to the server cache, instructs the first node to transmit the first data to the third node.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a configuration of a parallel processing device according to an embodiment;

FIG. 2 illustrates a hardware configuration of a node;

FIG. 3 is a view or explaining allocation of a server to a node;

FIG. 4 illustrates the relationship between a server cache and client cache;

FIG. 5 illustrates a functional configuration of a network file system according to the embodiment;

FIG. 6 illustrates client caches and server caches;

FIG. 7A and FIG. 7B illustrate data structures of a slave management table and CPU memory position information;

FIG. 8A and FIG. 8B illustrate data structures of a remote cache management table and CPU memory position information;

FIG. 9 is a flow chart illustrating a flow for processing of a slave management table by a cache management unit;

FIG. 10 is a flow chart illustrating a flow of empty node search processing;

FIG. 11 is a flow chart illustrating a flow of file management processing by a client;

FIG. 12 is a flow chart illustrating a flow of file management processing by a file server;

FIG. 13 is a flow chart illustrating a flow of client cache management processing by a cache management unit;

FIG. 14 is a flow chart illustrating a flow of processing by a backing store management unit;

FIG. 15 is a flow chart illustrating a flow of memory cache operation instruction processing to a slave memory cache server by a slave management unit;

FIG. 16 is a flow chart illustrating a flow of processing by a master handling unit;

FIG. 17 is a flow chart illustrating a flow of processing by a friend handling unit;

FIG. 18 is a flow chart illustrating a flow of switching processing by a switching master daemon;

FIG. 19 is a flow chart illustrating a flow of switching processing by a switching sub-daemon;

FIG. 20A and FIG. 20B are flow charts illustrating a flow of switching processing of the switching master daemon for controlling the switching to the server cache based on a usage state of a region that can be used as a client cache;

FIG. 21A and FIG. 21B are flow charts illustrating a flow of switching processing of the switching sub-daemon for controlling the switching of the server cache based on a usage state of a region that can be used as a client cache;

FIG. 22 is a view illustrating a case in which a file cache is stored in a main memory of a client;

FIG. 23 is a view illustrating a secondary cache disposed in the cache server; and

FIG. 24 is a view illustrating a server cache disposed in the cache server.

### DESCRIPTION OF EMBODIMENT

The following is a detailed explanation of an embodiment of a parallel processing device and a memory cache control method as disclosed in the present application based on the drawings. The embodiment is not intended to limit the techniques disclosed herein.

### Embodiment

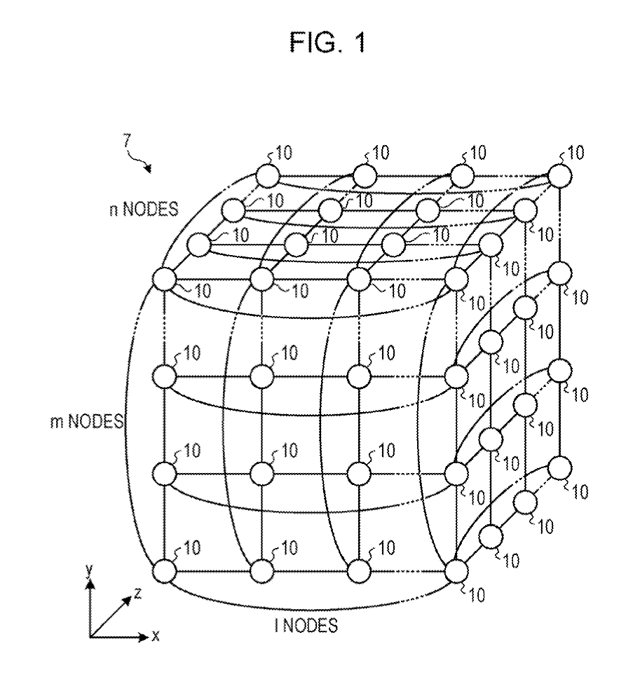

A parallel processing device as in the embodiment will be discussed first. FIG. 1 illustrates a configuration of a parallel processing device according to the embodiment. As, illustrated in FIG. 1, a parallel processing device 7 is configured so that I number of nodes 10 in the X-axis direction, m number of nodes 10 in the Y-axis direction, and n number of nodes 10 in the Z-axis direction are connected in a truss shape, with l, m, and n being positive integers. While FIG. 1 depicts a case in which the nodes 10 are disposed in a three-dimensional manner, the nodes 10 may also be disposed in other dimensions such as in a two-dimensional manner or a six-dimensional manner. The nodes 10 may also be disposed in a mesh shape.

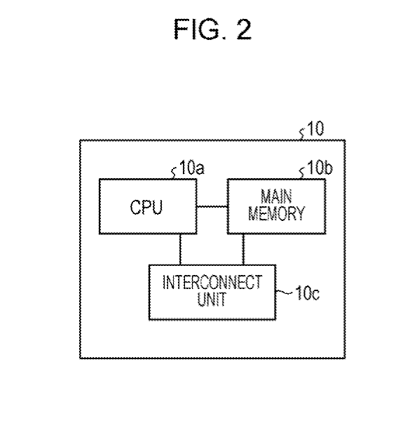

The nodes 10 are information processors that perform information processing. A job of a user is processed in parallel by a plurality of nodes 10. FIG. 2 illustrates a hardware configuration of a node. As illustrated in FIG. 2, each node 10 has a CPU 10a, a main memory 10b, and an interconnect unit 10c.

The CPU 10a is a central processing device for reading and executing programs in the main memory lobo. The main memory 10b is a memory for storing, for example, programs and mid-execution results of the programs. The interconnect unit 10c is a communication device for communication with other nodes 10.

The interconnect unit 10c has a remote direct memory access (RDMA) function. That is, the interconnect unit 10c is able to transfer data stored in the main memory 10b to another node 10 without the mediation of the CPU 10a, and is able to write data received form another node 10 to the main memory 10b without the mediation of the CPU 10a.

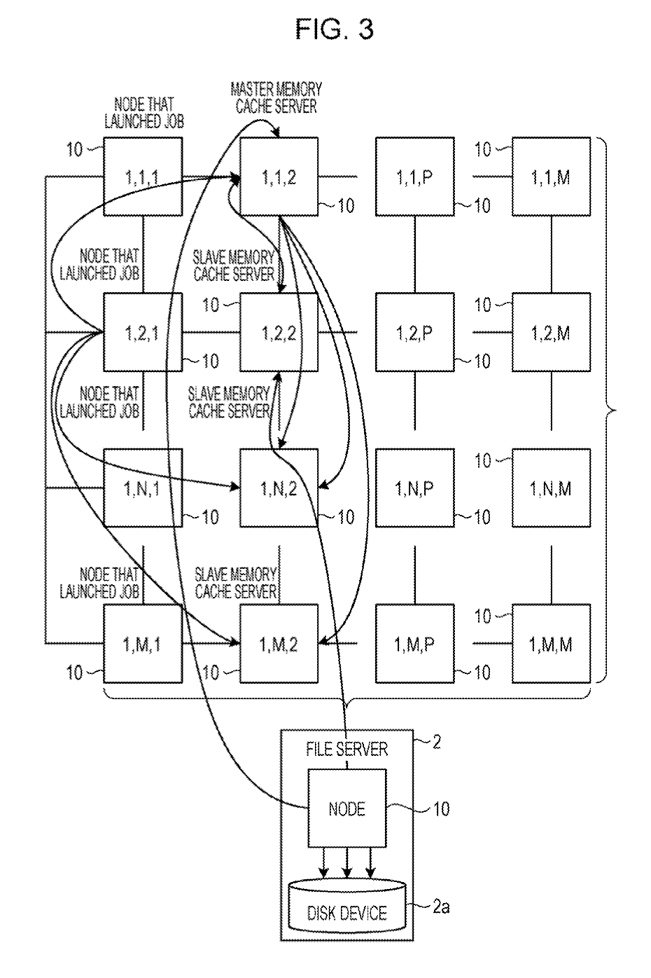

Next, the allocation of servers to the nodes 10 will be discussed. FIG. 3 is a view for explaining the allocation of a server to a node. As illustrated in FIG. 3, one node 10 has a disk device 2a and operates as a file server 2. The file server 2 stores files in the disk device 2a and stores data to be used by the other nodes 10.

The nodes 10 include nodes that are used for a job and nodes that are not used for the job. In FIG. 3, M number of nodes 10 from (1,1,1) to (1,M,1) are used for a job, namely the nodes 10 that launch the job, and M×(M−1) number of nodes 10 from (1,1,2) to (1,M,M) are empty nodes 10 that are not used for the job. The nodes 10 (1,1,1) to (1,M,M) and the file server 2 in FIG. 3 represent a portion of the node group depicted in FIG. 1 and the symbols N, P, and M in FIG. 3 have no relation to the symbols l, m, and n in FIG. 1.

A master memory cache server and a plurality of slave memory cache servers are allocated to empty nodes 10 in the proximity of the nodes 10 that launched the jobs. “In the proximity of” in this case represents a distance of one to three hops.

Each of the slave memory cache servers store a memory cache ire the main memory 10b. The memory caches include client caches and server caches. The master memory cache server manages the memory caches stored by the slave memory cache servers.

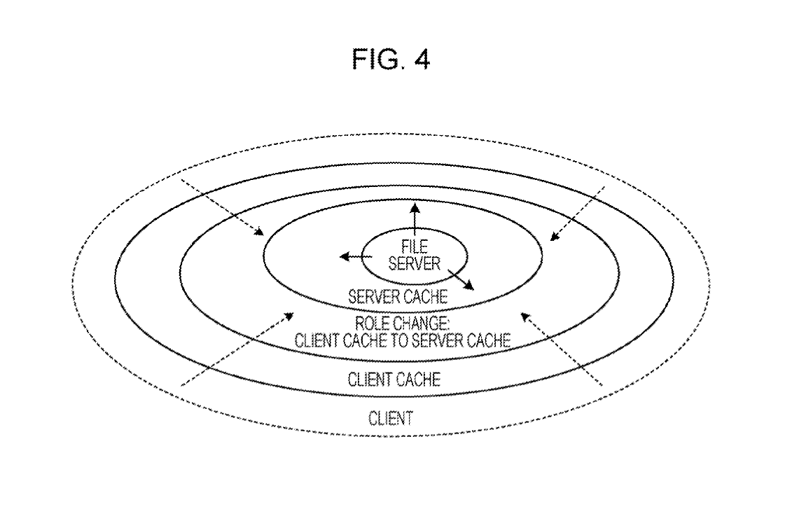

FIG. 4 illustrates the relationship between a server cache and a client cache. A server cache is a cache of copies of files in the file server 2 disposed in the main memory 10b of another node 10 in order to increase the speed of the file server 2. Normally, read-only data is stored in the server caches. The server caches may be in a plurality of nodes 10 for load distribution and redundancy.

A client cache is a cache of copies of file caches in the client disposed in the main memory 10b of another node 10. The clients in this case are the nodes 10 that launched the job. The client caches may be in a plurality of nodes 10 for load distribution and redundancy.

When copying of the client caches is performed in multiple stages during the memory cache control according to the embodiment, a client cache is considered the same as a server cache and a notification is sent to the client indicating that the writing of the contents of the files to the file server 2 has been completed. Copying of the client cache in multiple stages in this case signifies that a file block for which the writing was performed is copied to another client cache or to the file cache of the file server 2. Furthermore, considering the client cache the same as the server cache signifies that the client cache is changed to a server cache. By changing the client cache to a server cache, the writing to the file server 2 and the reading from the file server 2 thereafter are made unnecessary when the data is used in a subsequent job.

When a file block that is the same as the client cache is already present in the server cache, the memory cache control according to the embodiment involves discarding the file block of the server cache at the point in time that the client is notified that the writing to the file server 2 is completed. The timing of actually writing back the files to the disk device 2a of the file server 2 after the notification of the completion of the writing to the file server, is controlled by the file server 2.

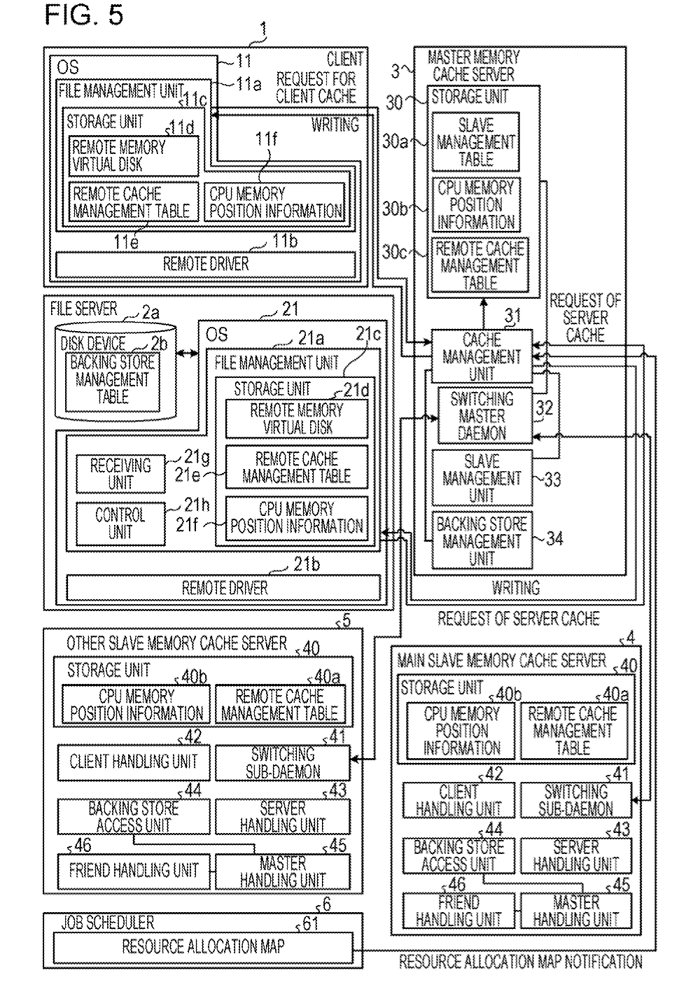

Next, a functional configuration of a network file system according to the embodiment will be explained. FIG. 5 illustrates a functional configuration of a network file system according to the embodiment. As illustrated in FIG. 5, the network file system according to the embodiment has a client 1, the file server 2, a master memory cache server 3, a main slave memory cache server 4, another slave memory cache server 5, and a job scheduler 6.

The client 1 is the node 10 that launched the job. The file server 2 stores the files used by the client 1 in the disk device 2a. The master memory cache server 3 manages the client caches and the server caches stored by the slave memory cache servers. While only one client 1 is depicted in FIG. 5, there generally is a plurality of clients 1,

The main slave memory cache server 4 and the other slave memory cache server 5 are slave memory cache servers that store the client caches and the server caches. Normally, the main slave memory cache server 4 is used as the slave memory cache server. When the main slave memory cache server 4 is not used, the other slave memory cache server 5 is used as the slave memory cache server. There is generally a plurality of other slave memory cache servers 5.

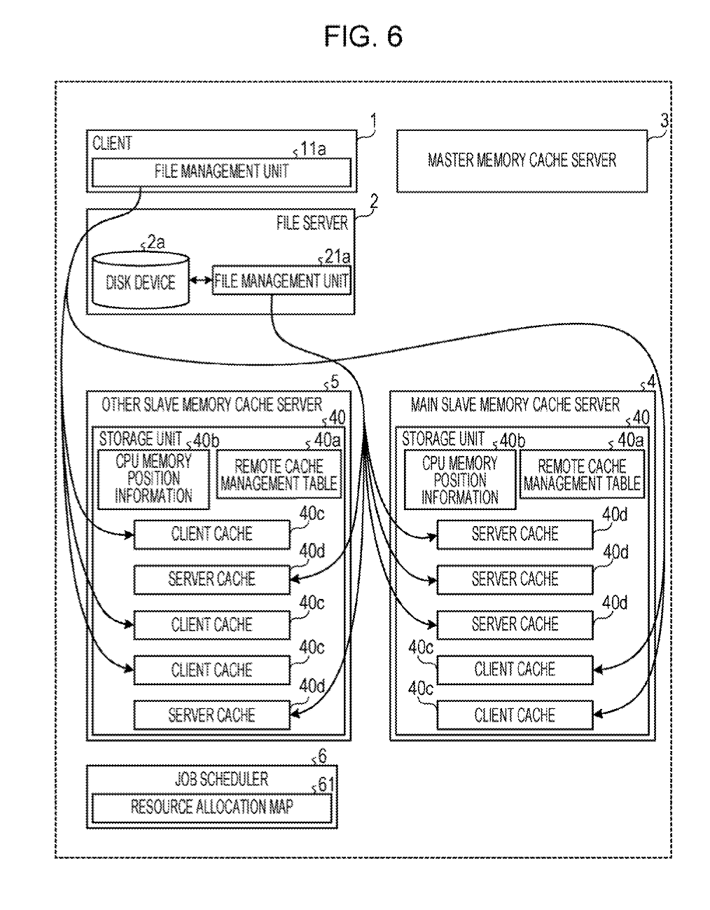

FIG. 6 illustrates client caches and sever caches stored by the main slave memory cache server 4 and the other slave memory cache server 5. As illustrated in FIG. 6, the main slave memory cache server 4 and the other slave memory cache server 5 each store a plurality of client caches 40c and server caches 40d. The client caches 40c and the server caches 40d are stored in storage units 40 of the slave memory cache servers.

The job scheduler 6 performs scheduling for executing jobs. The job scheduler 6 allocates jobs to the nodes 10, creates a resource allocation map 61, and notifies the master memory cache server 3.

As illustrated in FIG. 5, the master memory cache server 3 has a storage unit 30, a cache management unit 31, a switching master daemon 32, a slave management unit 33, and a backing store management unit 34.

The storage unit 30 stores information for managing the memory caches. Specifically, the storage unit 30 stores a slave management table 30a, CPU memory position information 30b, and a remote cache management table 30c. The storage unit 30 corresponds to the main memory 10b depicted in FIG. 2.

Information for managing the memory caches disposed in the slave memory cache servers in each slave memory cache server is registered in the slave management table 30a. The CPU memory position information 30b is information that pertains to the file blocks in the main memory 10b.

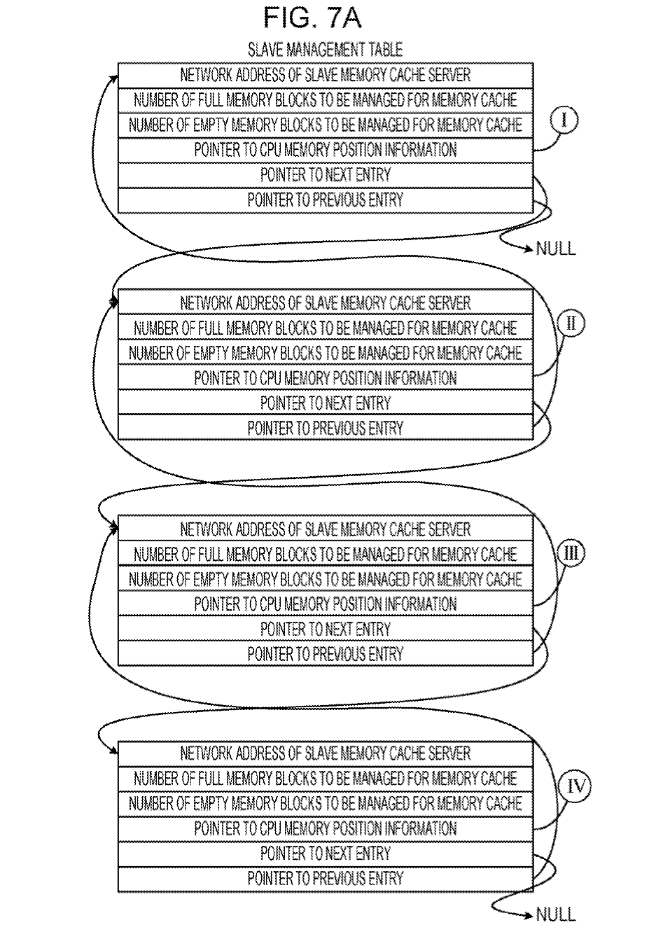

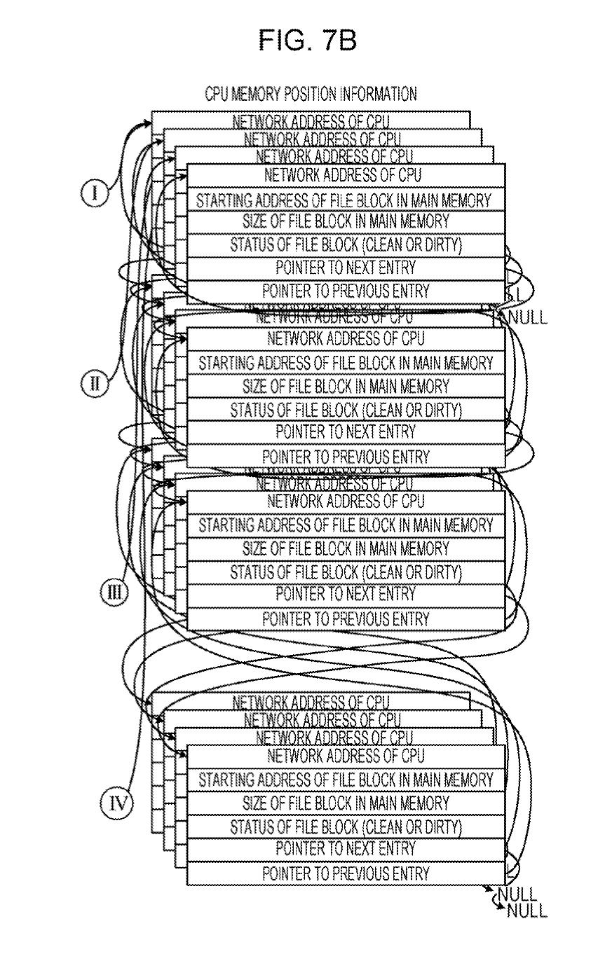

FIGS. 7A and 7B illustrate data structures of the slave management table 30a and the CPU memory position information 30b. As illustrated in FIG. 7, the slave management table 30a is a table in which entries for each cache memory are connected by bi-directional pointers. The entries include a network address of the slave memory cache server, the number of full memory blocks to be managed for the memory cache, the number of empty memory blocks to be managed for the memory cache, and a pointer to the CPU memory position information. The entries further include a pointer to the next entry and a pointer to the previous entry.

The CPU memory position information 30b is information in which the entries in each file block are connected by bi-directional pointers. The entries include the network address of the CPU, the starting address of the file block in the main memory 10b, the size of the file block in the main memory 10b, and the status of the file block, namely, “clean” or “dirty”, “Clean” indicates that no writing has been performed to the file block in the main memory 10b, and “dirty” indicates that writing has been performed to the file block in the main memory 10b. The entries further include a pointer to the next entry and a pointer to the previous entry.

The remote cache management table 30c includes information for managing the address position in the main memory 10b of the node 10 to which the file block is disposed as the memory cache.

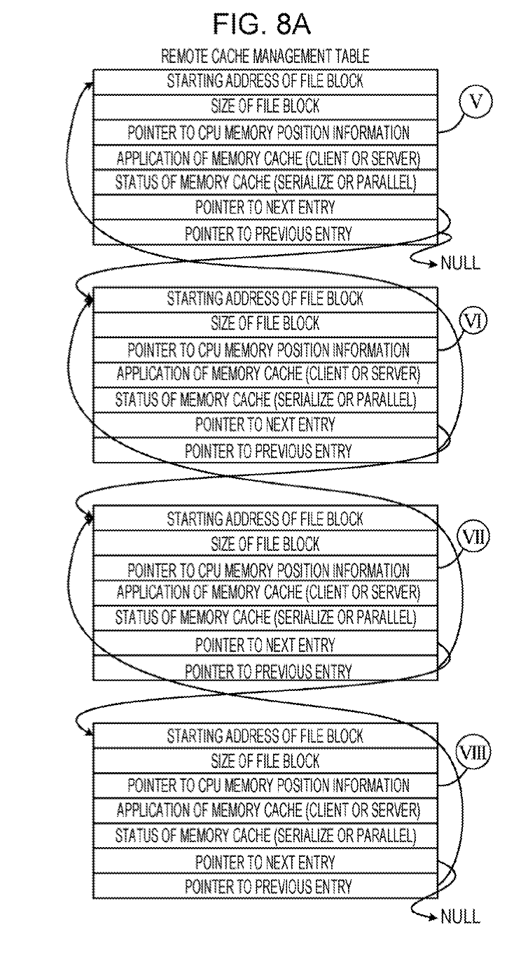

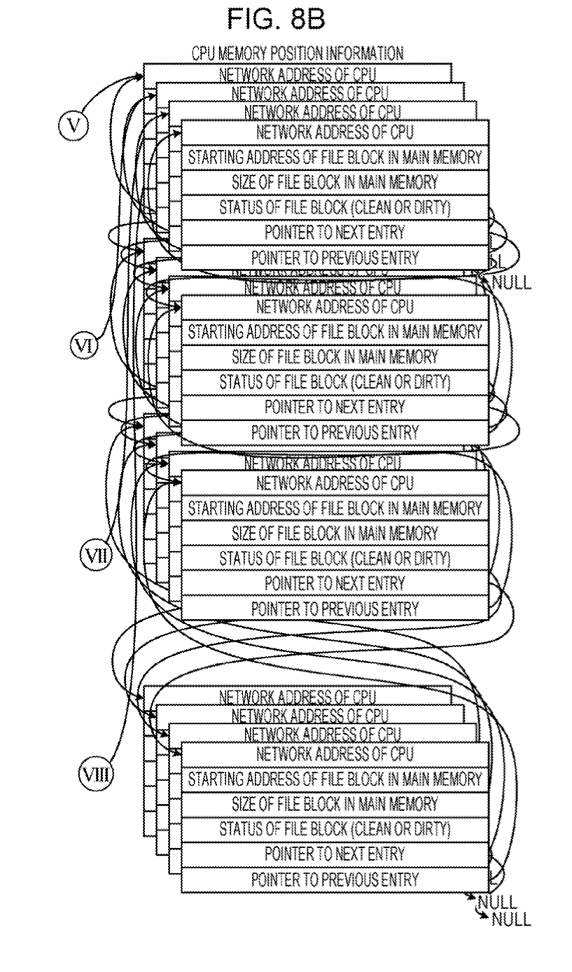

FIGS. 8A and 88 illustrate data structures of the remote cache management table 30c and the CPU memory position information 30b. As illustrated in FIG. 8, the remote cache management table 30c is a table in which the entries for each cache memory are connected by bi-directional pointers. The entries include the starting address of the file, block, the size of the file block, the pointer to the CPU memory position information, the use of the memory cache, namely a client or a server, and the status of the memory cache, namely serialized or parallel. The entries further include a pointer to the next entry and a pointer to the previous entry.

The cache management unit 31 manages the allocation, release, writing and reading of the memory caches. The cache management unit 31 receives a request of the client cache 40c from the client 1, or a request of the server cache 40d from the file server 2, and issues a request to the slave management unit 33 to perform a cache memory operation instruction to the slave memory cache server.

The cache management unit 31 also updates the slave management table 30a and the remote cache management table 30c. When a memory cache allocation, release, or writing is performed, the cache management unit 31 periodically transmits the remote cache management table 30c to the client 1, the file server 2, and the slave memory cache server to enable updating.

The transmission of the remote cache management table 30c involves the cache management unit 31 performing a RDMA transfer at the same time to the client 1, the file server 2, and the slave memory cache server. The cache management unit 31 uses a group communication interface (MPI_BCAST) of a message passing interface (MPI) when performing the RDMA transfer.

The cache management unit 31 does not lock the contents of the memory used by the CPU 10a and confirms that the contents of the memories between the two nodes 10 match in order to confirm the completion of the communication of the RDMA transfer. The cache management unit 31 uses an exclusive OR (EXOR) operation of the REDUCE interface (MPI_REDUCE) of the MPI for the confirmation.

Furthermore, the cache management unit 31 refers to the slave management table 30a and determines whether the job is allocated to a slave memory cache server when receiving the resource allocation map 61 from the job scheduler 6. If the job is allocated to the slave memory cache server, the cache management unit 31 searches for an empty node 10, requests the slave management unit 33 to move to the empty node 10 of the slave memory cache server to which the job is allocated, and updates the slave management table 30a.

When no empty node 10 is found, the cache management unit 31 requests the slave management unit 33 to save from the slave memory cache server to which the job is allocated to the file server 2.

The switching master daemon 32 cooperates with a switching, sub-daemon 41 of the slave memory cache server and carries out switching from the client cache 40c to the server cache 40d. The switching master daemon 32 updates the remote cache management table 30c with regard to the memory cache that performed the switching from the client cache 40c to the server cache 40d.

The slave management unit 33 instructs the allocation or release of the slave memory cache server based on the request of the cache management unit 31. The slave management unit 33 also instructs the moving to the slave memory cache server or the saving from the slave memory cache server to the file server 2 based on the request of the cache management unit 31.

The moving to the empty node 10 of the slave memory cache server signifies moving the contents of the memory cache of the slave memory cache server to the empty node 10. The saving from the slave memory cache server to the file server 2 signifies writing the contents of the memory cache of the slave memory cache server to the disk device 2a of the file server 2.

The backing store management unit 34 updates a backing store management table 2b stored in the disk device 2a of the file server 2. The backing store management table 2b is a table for managing the reading and writing of data between the cache memory and the disk device 2a.

The main slave memory cache server 4 and the other slave me cache server 5 have the same functional configurations as the slave memory cache server. The following is an explanation of the functional configuration of the slave memory cache server. The slave memory cache server has a storage unit 40, the switching sub-daemon 41, a client handling unit 42, a server handling unit 43, a backing store access unit 44, a master handling unit 45, and a friend handling unit 46.

The storage unit 40 stores a remote cache management table 40a and CPU memory position information 40b. The data structure of the remote cache management table 40a is the same as the data structure of the remote cache management table 30c. The data structure of the CPU memory position information 40b is the same as the data structure of the CPU memory position information 30b. As illustrated in FIG. 6, the storage unit 40 stores the client cache 40c and the server cache 40d. The storage unit 40 corresponds to the main memory 10b depicted in FIG. 2.

The switching sub-daemon 41 cooperates with the switching mast daemon 32 of the master memory cache server 3 and carries out switching from the client cache 40c to the server cache 40d. The switching sub-daemon 41 performs the switching from the client cache 40c to the server cache 40d when the use of the client cache 40c is finished and the contents of the client cache 40c are transmitted to the file server 2.

The client handling unit 42 receives write requests and read requests corresponding to the client cache 40c from the client 1 and performs data writing to the client cache 40c and data reading from the client cache 40c.

The server handling unit 43 receives write requests and read requests corresponding to the server cache 40d from the file server 2 and performs data writing to the server cache 40d and data reading from the server cache 40d.

The backing store access unit 44 requests the file server 2 to read and transmit the files of the disk device 2a and writes the transmitted files to the memory cache. Moreover, the backing store access unit 44 transmits the contents of the client cache 40c to the file server 2 and requests the file server 2 to write the contents of the client cache 40c to the disk device

The backing store access unit 44 uses the MPI group communication interface (MPI_BCAST) and performs ROMA transferring to the file server 2 when transmitting the contents of the client cache 40c to the file server 2. Further, the backing store access unit 44 does not lock the memory contents used by the CPU 10a when confirming the communication completion of the RDMA transfer. The backing store access unit 44 uses an exclusive OR (EXOR) operation of the MPI REDUCE interface (MPI_REDUCE) and confirms that the memory contents match with the file server 2.

The master handling unit 45 uses the friend handling unit 46 and allocates or releases the cache memory based on an allocation instruction or a release instruction from the slave management unit 33. Moreover, the master handling unit 45 instructs the friend handling unit 46 to move to the empty node 10 of the slave memory cache server based on a move instruction from the slave management unit 33. The master handling unit 45 also instructs the backing store access unit 44 to save to the file server 2 of the slave memory cache server based on a saving instruction from the slave management unit 33.

The friend handling unit 46 cooperates with the friend handling unit 46 of another slave memory cache server and performs processing related to copying the memory cache. Specifically, the friend handling unit 46 makes a copy of the memory cache in the other slave memory cache server based on the allocation instruction of the master handling unit 45.

The friend handling unit 46 uses the MN group communication interface (MPI_BCAST) and performs RDMA transfer at the same time with a plurality of other slave memory cache servers when making the copies of the memory cache in the other slave memory cache servers. Further, the friend handling unit 46 does not lock the memory contents used by the CPU 10a when confirming the communication completion of the RDMA transfer. The friend handling unit 46 uses an exclusive OR (EXOR) operation of the MPI REDUCE interface (MPI_REDUCE) and confirms that the memory contents match with the other slave memory cache server.

The friend handling unit 46 also allocates memory caches based on instructions from the friend handling units 46 of other slave memory cache servers.

The friend handling unit 46 also instructs the friend handling units 46 of other slave memory cache servers to release memory caches based on the release instruction of the master handling unit 45. The friend handling unit 46 also releases memory caches based on instructions from the friend handling units 46 of other slave memory cache servers.

The friend handling unit 46 copies the contents of all of the memory caches from a move origin node 10 to a move destination node 10 based on a move instruction of the master handling unit 45. The friend handling unit 46 uses the MPI group communication interface (MPI_BCAST) and performs RDMA transfer to a plurality of move destination nodes 10 when making the copies. Further, the friend handling unit 46 does not lock the memory contents used by the CPU 10a when confirming the communication completion of the RDMA transfer. The friend handling unit 46 uses an exclusive OR (EXOR) operation of the REDUCE interface (MPI_REDUCE) of the MPI and confirms that the memory contents match with the move destination node 10.

The friend handling unit 46 also instructs the friend handling units 46 of other slave memory cache servers to release all the memory caches based on the saving instruction of the master handling unit 45.

An OS 11 operates in the client 1, and the OS 11 has a file management unit 11a that manages the files, and a remote driver 11b that communicates with other nodes 10. The file management unit 11a has a storage unit 11c.

The storage unit 11c has a remote memory virtual disk 11d. The remote memory virtual disk 11d is a region for storing file caches. The storage unit 11c also stores a remote cache management table 11e and CPU memory position information 11f. The data structure of the remote cache management table 11e is the same as the data structure of the remote cache management table 30c. The data structure of the CPU memory position information 11f is the same as the data structure of the CPU memory position information 30b. The storage unit 11c corresponds to the main memory 10b depicted in FIG. 2.

An OS 21 operates in the file server 2, and the OS 21 has a file management unit 21a that manages the files, and a remote driver 21b that communicates with other nodes 10. The file management unit 21a has a storage unit 21c, a receiving unit 21g, and a control unit 21h.

The storage unit 21c has a remote memory virtual disk 21d. The remote memory virtual disk 21d is a region for storing file caches. The storage unit 21c also stores a remote cache management table 21e and CPU memory position information 21f. The data structure of the remote cache management table 21e is the same as the data structure of the remote cache management table 30c. The data structure of the CPU memory position information 21f is the same as the data structure of the CPU memory position information 30b. The storage unit 21c corresponds to the main memory 10b depicted in FIG. 2.

Upon receiving a data transmission request from the client 1, the receiving unit 21g refers to the remote cache management table 21e and determines if the server cache 40d of the requested data is in the slave memory cache server.

When the receiving unit 21g determines that the server cache 40d is in the slave memory cache server, the control unit 21h instructs the slave memory cache server to transmit the data of the server cache 40d to the client 1.

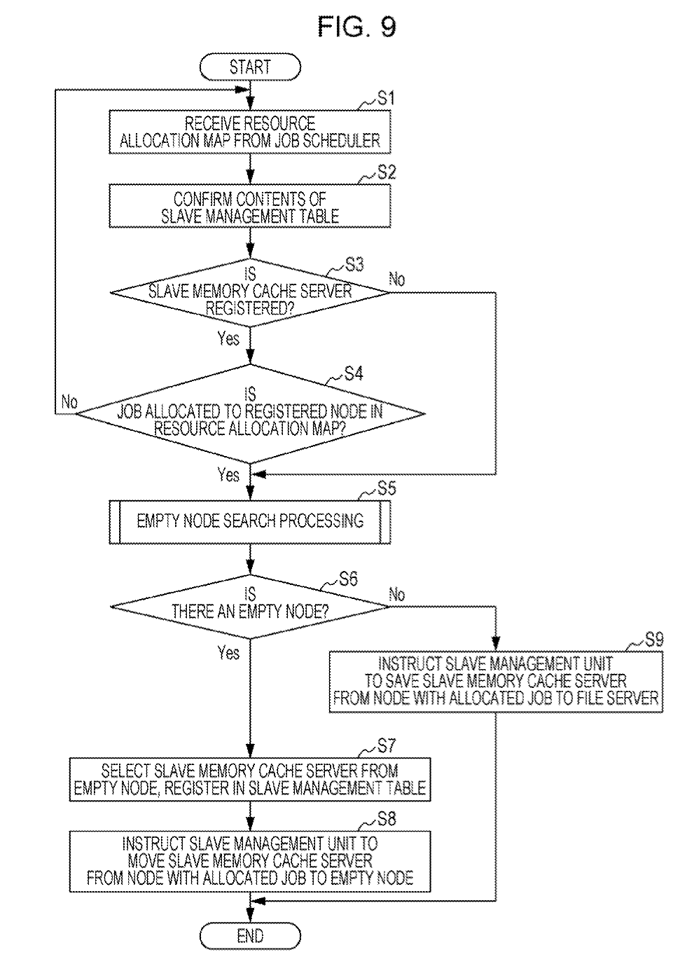

The following is an explanation of the flow of the processing of the slave management table 30a by the cache management unit 31 of the master memory cache server 3. FIG. 9 is a flow chart illustrating a flow for processing of the slave management table 30a by the cache management unit 31. As illustrated in FIG. 9, the cache management unit 31 receives the resource allocation map 61 from the job scheduler 6 (step S1) and confirms the contents of the slave management table 30a (step S2).

The cache management unit 31 then determines if the slave memory cache server is registered in the slave management table 30a (step S3), and if the slave memory cache server is not registered, the processing advances to step S5. However, if the slave memory cache server is registered, the cache management unit 31 determines whether a job is allocated to the registered node 10 in the resource allocation map 61 (step S4), and if no job is allocated, the processing returns to step S1.

However, if a job is allocated, the cache management unit 31 performs empty node search processing for searching for an empty node 10 in order to find an empty node 10 that is the move destination of the slave memory cache server (step S5). The cache management unit 31 then determines whether there is an empty node 10 (step S6), and if there is an empty node 10, the cache management unit 31 selects the slave memory cache server from the empty node 10 and registers the slave memory cache server in the slave management table 30a (step S7).

The cache management unit 31 then instructs the slave management unit 33 to move the slave memory cache server from the node 10 to which the job is allocated to the empty node 10 (step S8).

However, if there is no empty node 10, the cache management unit 31 then instructs the slave management unit 33 to save the slave memory cache server from the node 10 to which the job is allocated to the file server 2 (step 59).

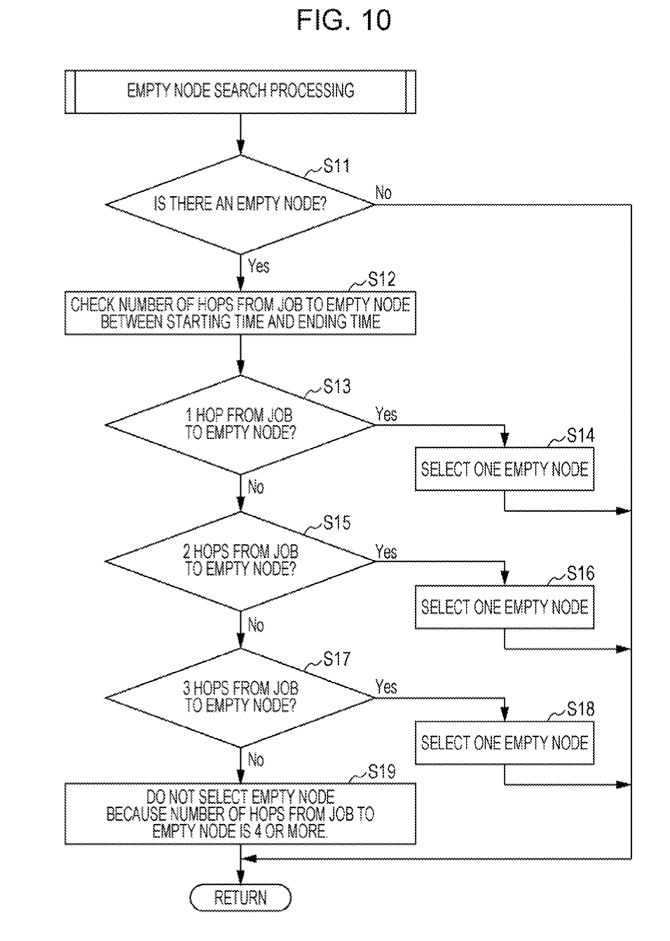

FIG. 10 is, a flow chart illustrating a flow for empty node search processing. As illustrated in FIG. 10, the cache management unit 31 determines whether there is an empty node 10 (step S11), and the processing is finished if there is no empty node 10.

However, if there is an empty node 10, the cache management unit 31 checks the number of hops from the job to the empty node 10 between a starting time and an ending time (step S12). The cache management unit 31 then determines whether the number of hops from the job to the empty node 10 is one (step S13), and if the number of hops is one, the cache management unit 31 selects one empty node 10 (step S14).

If the number of hops from the job to the empty node 10 is not one, the cache management unit 31 then determines whether the number of hops from the job to the empty node 10 is two (step S15), and if the number of hops is two, the cache management unit 31 selects one empty node 10 (step S16).

If the number of hops from the job to the empty node 10 is not two, the cache management unit 31 then determines whether the number of hops from the job to the empty node 10 is three (step S17), and if the number of hops is three, the cache management unit 31 selects one empty node 10 (step S18).

However, if the number of hops from the job to the empty node 10 is not three, the cache management unit 31 does not select an empty node 10 because the number of hops from the job to the empty node 10 is four or more (step S19).

In this way, when a job is allocated to the slave memory cache server, the cache management unit 31 instructs the slave management unit 33 to perform the move by the slave memory cache server to the empty node 10, thereby avoiding adverse effects on the execution of the job.

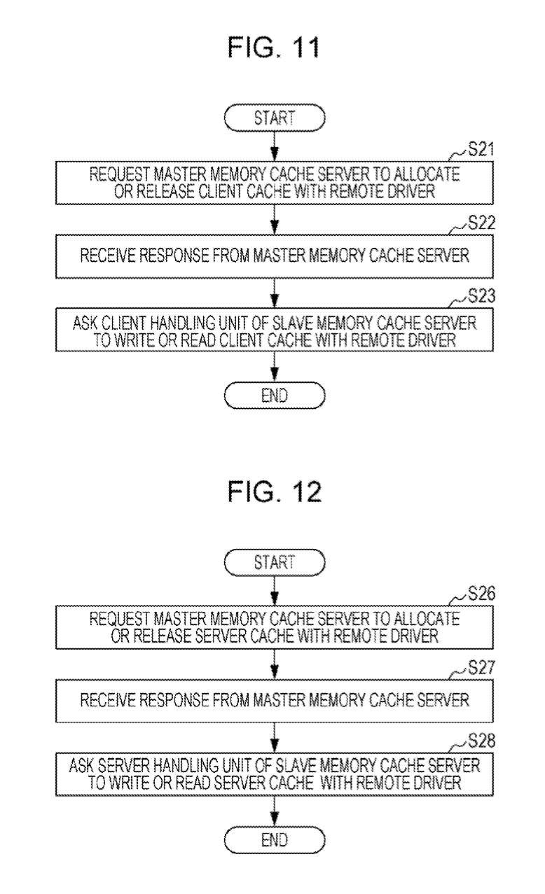

The following is an explanation of a flow of file management processing by the client 1. FIG. 11 is a flow chart illustrating a flow of file management processing by the client 1. As illustrated in FIG. 11, the client 1 requests the master memory cache server 3 to allocate or release the client cache 40c with the remote driver 11b (step S21).

The client 1 then waits for a response from the master memory cache server 3, and receives the response from the master memory cache server 3 (step S22). If the allocation of the client cache 40c is requested, the client 1 then asks the client handling unit 42 of the slave memory cache server to write or read the client cache 40c with the remote driver 11b (step S23).

In this way, the client 1 is able to use the client cache 40c by requesting the master memory cache server 3 to allocate or release the client cache 40c.

The following is an explanation of a flow of file management processing by the file server 2. FIG. 12 is a flow chart illustrating a flow of file management processing by the file server 2. As illustrated in FIG. 12, the file server 2 requests the master memory cache server 3 to allocate or release the server cache 40d with the remote driver 21b (step S26).

The file server 2 then waits for a response from the master memory cache server 3, and receives the response from the master memory cache server 3 (step S27). When the allocation of the server cache 40d is requested, the file server 2 then asks the server handling unit 43 of the slave memory cache server to write or read the server cache 40d with the remote driver 21b (step S28).

In this way, the file server 2 is able to use the server cache 40d by requesting the master memory cache server 3 to allocate or release the server cache 40d.

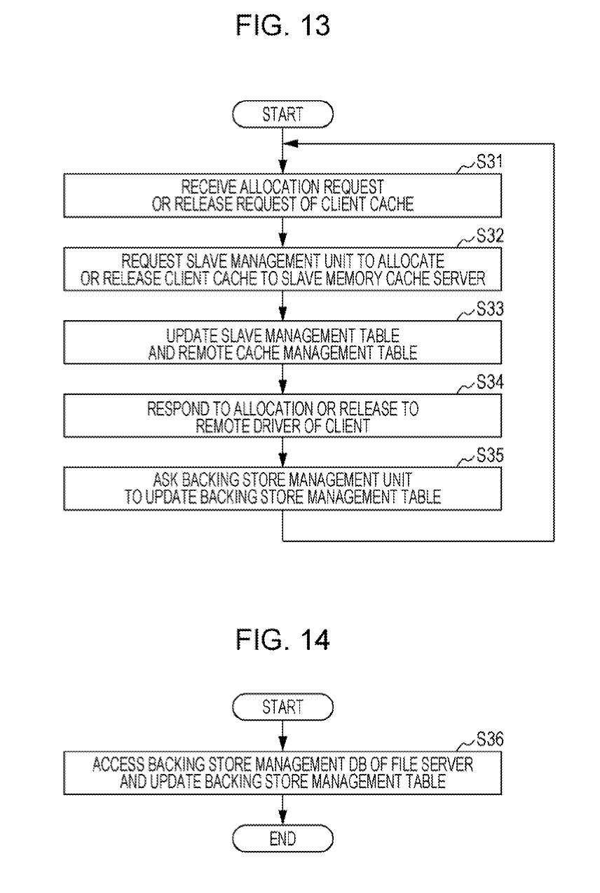

The following is an explanation of the flow of the client cache management processing by the cache management unit 31 of the master memory cache server 3. FIG. 13 is a flow chart illustrating a flow of client cache management processing by the cache management unit 31.

As illustrated in FIG. 13, the cache management unit 31 receives an allocation request or a release request of the client cache 40c (step S31). The cache management unit 31 then requests the slave management unit 33 to allocate or release the client cache 40c to the slave memory cache server (step S32).

The cache management unit 31 then updates the slave management table 30a and the remote cache management table 21e (step S33) and responds to the allocation or release to the remote driver 11b of the client 1 (step S34). The cache management unit 31 then asks the backing store management unit 34 to update the backing store management table 2b (step S35).

In this way, the cache management unit 31 is able to perform the allocation or release of the client cache 40c by requesting the allocation or release of the client cache 40c to the slave memory cache server through the slave management unit 33.

The following is an explanation of a flow for processing by the backing store management unit 34. FIG. 14 is a flow chart illustrating a flow of processing by the backing store management unit 34. As illustrated in FIG. 14, the backing store management unit 34 accesses a backing store management DB of the file server 2 and updates the backing store management table 2b (step S36).

In this way, the backing store management unit 34 accesses the backing store management DB of the file server 2 and updates the backing store management table 2b, whereby the server 2 is able to reliably perform the backing store.

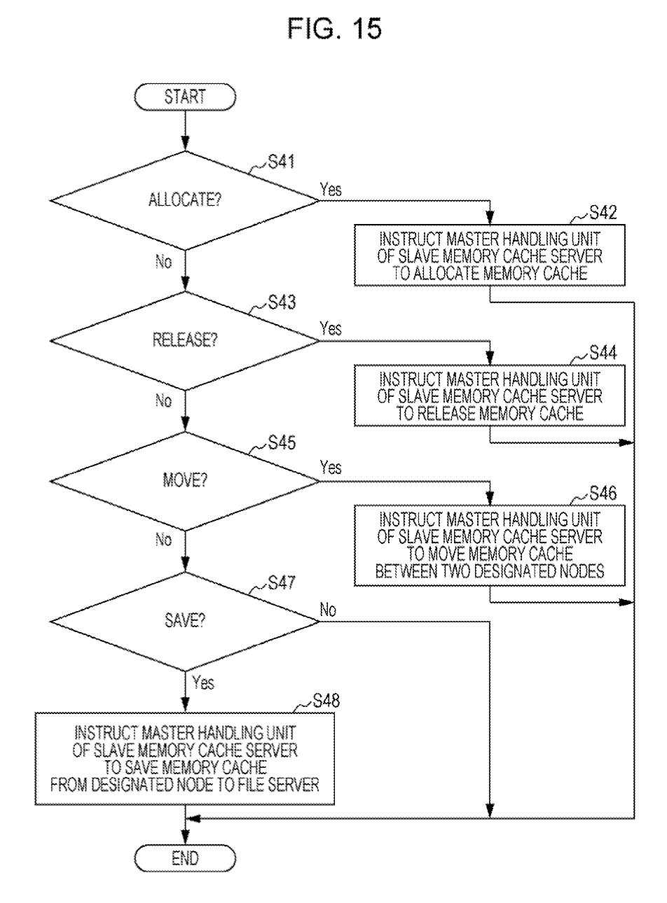

The following is an explanation of a flow of memory cache operation instruction processing to the slave memory cache server by the slave management unit 33. FIG. 15 is a flow chart illustrating a flow of memory cache operation instruction processing to a slave memory cache server by the slave management unit 33. The slave management unit 33 is requested to allocate or by the cache management unit 31 in the processing in step S32 depicted in FIG. 13, is instructed to move in the processing in step S8 depicted in FIG. 9, and is instructed to save in the processing in step S9 depicted in FIG. 9.

As illustrated in FIG. 15, the slave management unit 33 determines whether the request from the cache management unit 31 is an allocation request (step S41), and if the request is an allocation request, the slave management unit 33 instructs the master handling unit 45 of the slave memory cache server to allocate the memory cache (step S42).

However, if the request from the cache management unit 31 is not an allocation request, the slave management unit 33 determines if the request from the cache management unit 31 is a release request (step S43). If the request from the cache management unit 31 is a release request, the slave management unit 33 instructs the master handling unit 45 of the slave memory cache server to release the memory cache (step S44).

However, if the request from the cache management unit 31 is not a release request, the slave management unit 33 determines if the request from the cache management unit 31 is a move request (step S45). If the request from the cache management unit 31 is a move request, the slave management unit 33 instructs the master handling unit 45 of the slave memory cache server to move the memory cache between the two designated nodes 10 (step S46).

However, if the request from the cache management unit 31 is not a move request, the slave management unit 33 determines if the request from the cache management unit 31 is a save request (step S47), and if the request is not a save request, the processing is finished. However, if the request from the cache management unit 31 is a save request, the slave management unit 33 instructs the master handling unit 45 of the slave memory cache server to save the memory cache from the designated node 10 to the file server 2 (step S48).

In this way, the slave management unit 33 instructs the master handling unit 45 of the slave memory cache server to perform the memory cache operation based on the request from the cache management unit 31, whereby the master memory cache server 3 is able to perform the memory cache operation.

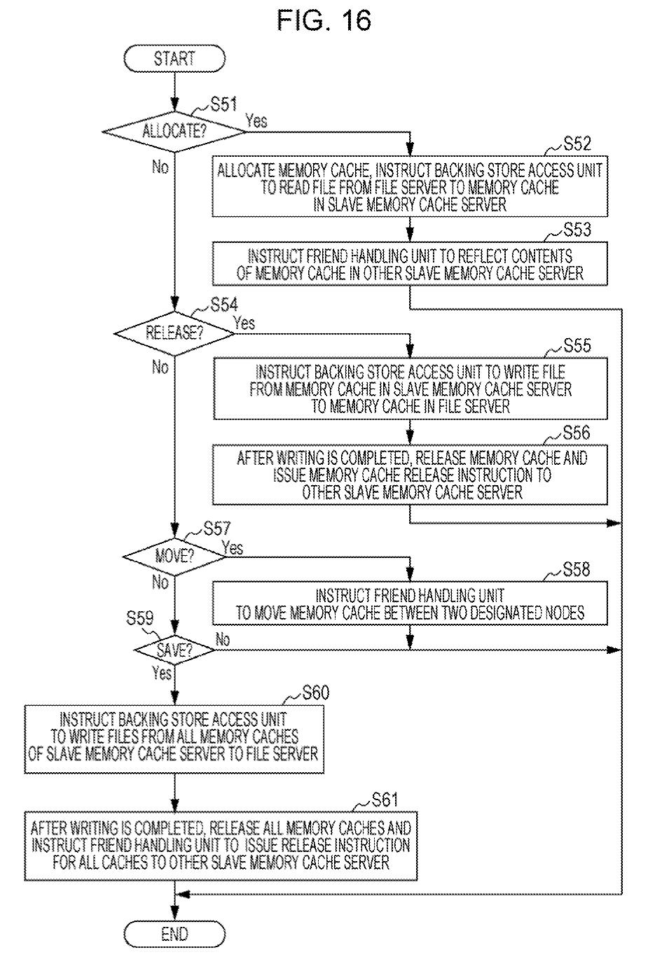

The following is an explanation of the flow of the processing by the master handling unit 45 of the slave memory cache server. FIG. 16 is a flow chart illustrating a flow of processing by the master handling unit 45

As illustrated in FIG. 16, the master handling unit 45 determines whether the instruction from the slave management unit 33 is an allocation instruction (step S51). If the instruction is an allocation instruction as a result thereof, the master handling unit 45 allocates the memory cache, and instructs the backing store access unit 44 to read the file from the file server 2 to the memory cache in the slave memory cache server (step S52). The master handling unit 45 then instructs the friend handling unit 46 so as to reflect the contents of the memory cache to the other slave memory cache server (step S53).

However, if the instruction from the slave management unit 33 is not an allocation instruction, the master handling unit 45 determines whether the instruction from the slave management unit 33 is a release instruction (step 554). If the instruction is a release instruction, the master handling unit 45 instructs the backing store access unit 44 to perform file writing from the memory cache in the slave memory cache server to the memory cache in the file server 2 (step S55). When the writing is completed, the master handling unit 45 releases the memory cache and instructs the friend handling unit 46 to issue a memory cache release instruction to the other slave memory cache server (step S56).

However, if the instruction from the slave management unit 33 is not a release instruction, the master handling unit 45 determines whether the instruction from the slave management unit 33 is a move instruction (step S57). If the instruction from the slave management unit 33 is a move instruction, the master handling unit 45 instructs the friend handling unit 46 to move the memory cache between the two designated nodes 10 (step S58).

However, if the instruction from the slave management unit 33 is not a move instruction, the master handling unit 45 determines whether the instruction from the slave management unit 33 is a save instruction (step S59). If the instruction is not a save instruction, the processing is finished. However, if the instruction is a save instruction, the master handling unit 45 instructs the backing store access unit 44 to perform file writing from all of the memory caches in the slave memory cache server to the file server 2 (step S60). The master handling unit 45 then releases all of the memory caches when the writing is completed, and instructs the friend handling unit 46 to issue a release instruction for all of the memory caches to the other slave memory cache server (step S61).

In this way, the master handling unit 45 performs the memory cache operations based on the instructions from the slave management unit 33, whereby the master memory cache server 3 is able to perform the memory cache operations.

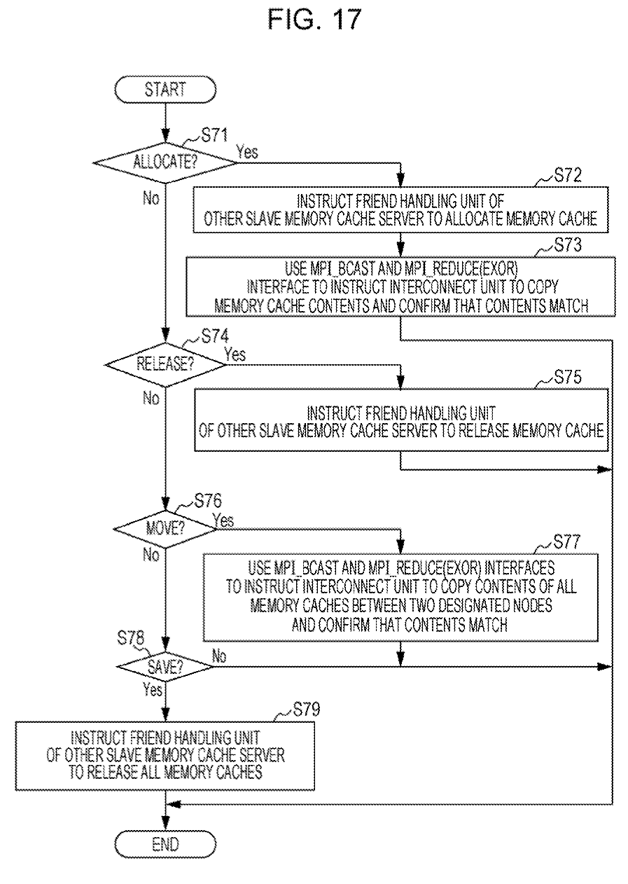

The following is an explanation of the flow of the processing by the friend handling unit 46. FIG. 17 is a flow chart illustrating a flow of processing by the friend handling unit 46. As illustrated in FIG. 17, the friend handling unit 46 determines whether the instruction from the master handling unit 45 is an allocation instruction (step S71).

If the instruction is an allocation instruction as a result thereof, the friend handling unit 46 instructs the friend handling unit 46 of the other slave memory cache server to allocate the memory cache (step S72). The friend handling unit 46 then uses the MPI_BCAST and the MPI_REDUCE (EXOR) interface and instructs the interconnect unit 10c to copy the contents of the memory cache and to confirm that the contents match (step S73).

However, if the instruction from the master handling unit 45 is not an allocation instruction, the friend handling unit 46 determines whether the instruction from the master handling unit 45 is a release instruction (step S74), If the instruction is a release instruction, the friend handling unit 46 instructs the friend handling unit 46 of the other slave memory cache server to release the memory cache (step S75).

However, if the instruction from the master handling unit 45 is not a release instruction, the friend handling unit 46 determines whether the instruction from the master handling unit 45 is a move instruction (step S76). If the instruction from the master handling unit 45 is a move instruction, the friend handling unit 46 performs the following processing. Namely, the friend handling unit 46 uses the MPI_BCAST and the MIDI_REDUCE (EXOR) interface and instructs the interconnect unit 10c to copy all of the contents of the memory cache between the two designated nodes 10 and to confirm that the contents match (step S77).

However, if the instruction from the master handling unit 45 is not a move instruction, the friend handling unit 46 determines whether the instruction from the master handling unit 45 is a save instruction (step S78). If the instruction is not a save instruction, the processing is finished. However, if the instruction is a save instruction, the friend handling unit 46 instructs the friend handling unit 46 of the other slave memory cache server to release all of the memory caches (step S79).

In this way, the friend handling unit 46 performs the memory cache operations of the other slave memory cache server based on the instructions from the master handling unit 45, whereby the slave memory cache server is able to achieve redundancy and load distribution of the memory caches.

The following is an explanation of a flow of the switching processing for switching the client cache 40c to the server cache 40d with the cooperation of the switching master daemon 32 of the master memory cache server 3 and the switching sub-daemon 41 of the slave memory cache server.

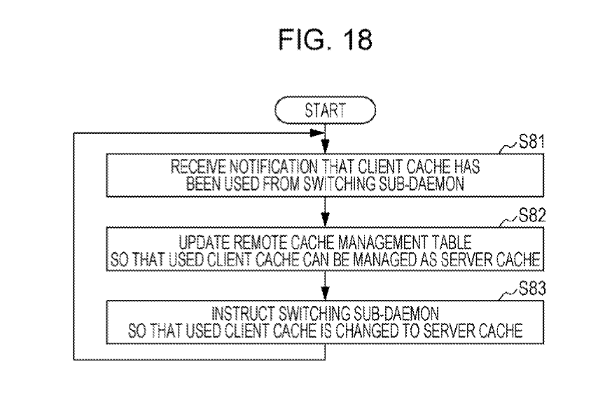

FIG. 18 is a flow chart illustrating a flow of switching processing by the switching master daemon 32. As illustrated in FIG. 18, the switching master daemon 32 waits for a notification from the switching sub-daemon 41 indicating that the client cache has been used, and receives the notification from the switching sub-daemon 41 indicating that the client cache has been used (step S81).

The switching master daemon 32 then updates the remote cache management table 11e so that the client cache 40c that has been used can be managed as the server cache 40d (step S82). The switching master daemon 32 then instructs the switching sub-daemon 41 to change the client cache 40c that has been used to the server cache 40d (step S83), and then the processing returns to step S81.

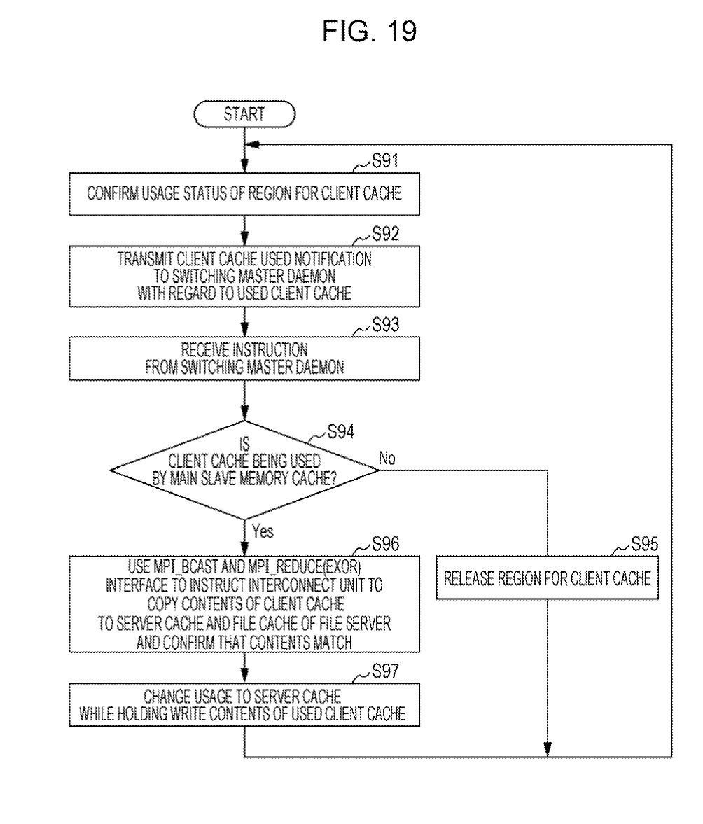

FIG. 19 is a flow chart illustrating a flow of switching processing by the switching sub-daemon 41. As illustrated in FIG,. 19, the switching sub daemon 41 confirms the usage status of the region for the client cache 40c (step. S91). The switching sub-daemon 41 then transmits, to the switching master daemon 32, a notification indicating that the client cache has been used with regard to the client cache 40c that has been used (step S92).

The switching sub-daemon 41 then waits for an instruction from the switching master daemon 32 and receives the instruction from the switching master daemon 32 (step S93). The switching sub-daemon 41 then determines whether the client cache 40c is being used by the main slave memory cache server 4 (step S94). If the client cache 40c is not being used by the main slave memory cache server 4 as a result thereof, the switching sub-daemon 41 releases the region for the client cache 40c (step S95), and the processing returns to step S91.

However, if the client cache 40c is being used by the main slave memory cache server 4, the switching sub-daemon 41 uses the MPI_BCAST and MPI_REDUCE (EXOR) interface to execute the following processing. Namely, the switching sub-daemon 41 instructs the interconnect unit 10c to copy the contents of the client cache 40c to the server cache 40d and to the file cache of the file server 2 and to confirm that the contents match (step S96). The switching sub-daemon 41 then changes the usage of the server cache 40d while holding the writing contents of the client cache 40c that have been used (step S97), and the processing returns to step S91.

In this way, the switching sob-daemon 41 cooperates with the switching master daemon 32 and switches the client cache 40c to the server cache 40d, whereby wasteful writing and reading to the disk device 2a can be suppressed.

As described above, the slave memory cache server stores the client cache 40c in the main memory 10b in the embodiment. The slave memory cache server then copies the contents of the client cache 40c to the file cache of the file server 2 when the client cache 40c has been used, Further, the file server 2 stores the data stored in the client cache 40c in the disk device 2a and stores the slave management table 30a and the remote cache management table 21e in the storage unit 21c.

The master memory cache server 3 then updates the remote cache management table 11e so that the client cache 40c that has been used can be managed as the server cache 40d when the master memory cache server 3 is notified by the switching sub-daemon 41 that the client cache 40c has been used. Furthermore, the master memory cache server 3 transmits the updated remote cache management table 11e to the file server 2. The switching master daemon 32 then instructs the switching sub-daemon 41 to change the client cache 40c that has been used to the server cache 40d.

The file server 2 then refers to the remote cache management table 11e and determines whether there is data in the slave memory cache server when a transmission request to transmit the changed data to the server cache 40d is received from the client 1. When it is determined that there is data in the slave memory cache server, the file server 2 instructs the slave memory cache server to transmit the changed data in the server cache 40d to the client

Therefore, the parallel processing device 7 is able to use the client cache 40c of the previous job as the server cache 40d of the next job. As a result, the writing of the client cache 40c to the disk device 2a and the reading of the server cache 40d from the disk device 2a become unnecessary. The data copied to the file cache of the file server 2 is written separately to the disk device 2a by the file server 2.

Moreover, the slave memory cache server uses the MPI group communication interface (MPI_BCAST) and performs RDMA transferring to the file server 2 when transmitting the contents of the client cache 40c to the file server 2 in the embodiment. Therefore, an increase in the load on the CPU 10a can be suppressed when the slave memory cache server transmits the contents of the client cache 40c to the file server 2.

Further, the slave memory cache server does not lock the memory contents used by the CPU 10a when the communication completion of the RDMA transfer is confirmed in the embodiment. The slave memory cache server uses an exclusive OR (EXOR) operation of the MPI REDUCE interface (MPI_REDUCE) and confirms that the memory contents match with the file server 2. Therefore, the slave memory cache server is able to confirm that the contents match with the file server 2 without adversely affecting the CPU 10a.

A case in which the client cache 40c is switched to the server cache 40d when the client cache 40c has been used has been explained in the embodiment. However, the switching to the server cache 40d can be controlled based on the usage status of the region that can be used as the client cache 40c. Accordingly, the switching master daemon 32 and the switching sub-daemon 41 that control the switching to the server cache 40d based on the usage status of the region that can be used as the client cache 40c will be explained.

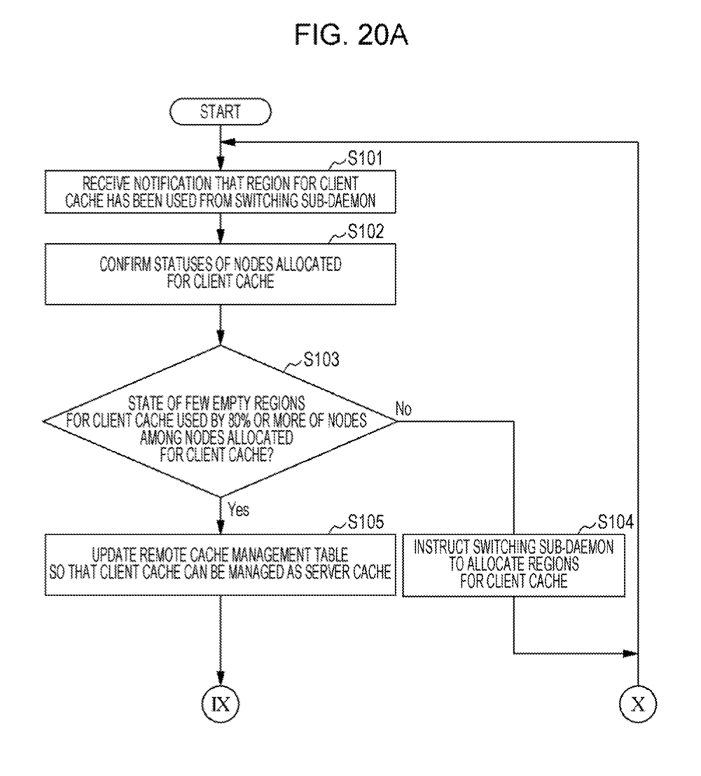

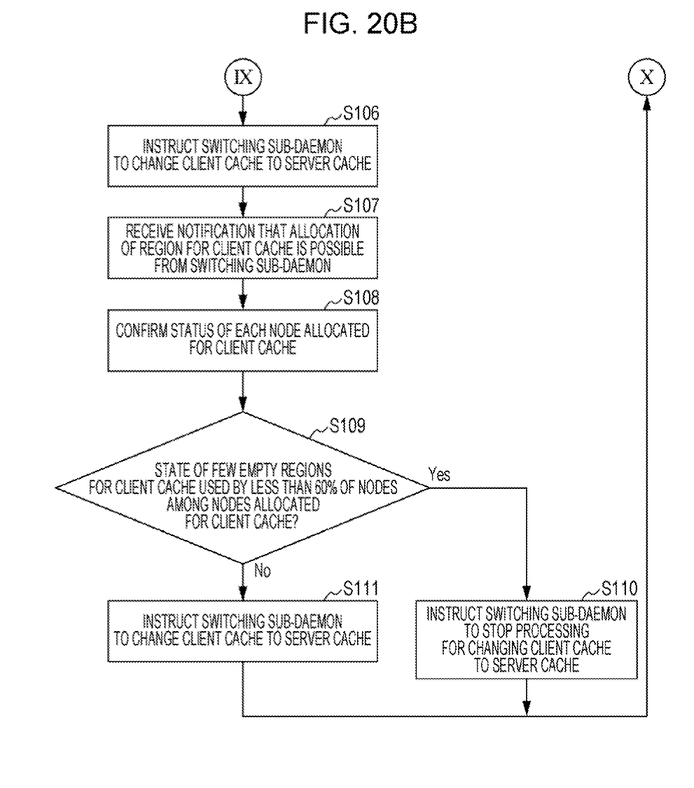

FIGS. 20A and 208 are flow charts illustrating a flow of switching processing of the switching master daemon 32 for controlling the switching to the server cache 40d based on a usage state of a region that can be used as the client cache 40c. As illustrated in FIG. 20, the switching master daemon 32 waits for a notification from the switching sub-daemon 41 indicating that the region for the client cache has been used, and receives the notification from the switching sub-daemon 41 indicating that the region for the client cache has been used (step S101).

The switching master daemon 32 then confirms the status of each node 10 allocated for the client cache 40c (step S102). The switching master daemon 32 then determines whether there is a state of few empty regions for the client cache 40c used by 80% or more of the nodes 10 among the nodes 10 allocated for the client cache 40c (step S103).

The state of there being few empty regions for the client cache 40c is the state of, for example, 80% or more of the regions for the client cache 40c being used. Moreover, the value of 80% used when determining whether there are few empty regions for the client cache 40c being used by 80% or more of the nodes 10 is an example and another value may be used.

If there is no state of there being few empty regions for the client cache 40c being used by 80% or more of the nodes 10, the switching master daemon 32 instructs the switching sub-daemon 41 to allocate regions for the client cache 40c (step S104).

However, if there is a state of there being few empty regions for the client cache 40c being used by 80% or more of the nodes 10, the switching master daemon 32 updates the remote cache management table 11e so that the client cache 40c can be managed as the server cache 40d (step S105). The switching master daemon 32 then instructs the switching sub-daemon 41 to change the client cache 40c to the server cache 40d (step S106).

The switching master daemon 32 then waits for a notification from the switching sub-daemon 41 indicating that the regions for the client cache can be allocated, and receives the notification from the switching sub-daemon 41 indicating that the regions for the client cache can be allocated (step S107). The switching master daemon 32 then confirms the status of each node 10 allocated to use the client cache 40c (step S108).

The switching master daemon 32 then determines whether there is a state of few empty regions for the client cache 40c used by less than 60% of the nodes 10 among the nodes 10 allocated for the client cache 40c (step S109). Here, the value of 60% is an example and another value may be used.

The switching master daemon 32 performs the following processing when there is a state of few empty regions for the client cache 40c used by less than 60% of the nodes 10. The switching master daemon 32 instructs the switching sub-daemon 41 to stop the processing for changing the client cache 40c to the server cache 40d (step S110). The processing of the switching master daemon 32 returns to step S101.

However, if there is no state of there being few empty regions for the client cache 40c to be used by less than 60% of the nodes 10, the switching master daemon 32 instructs the switching sub-daemon 41 to change the client cache 40c to the server cache 40d (step S111). The processing of the switching master daemon 32 returns to step S101.

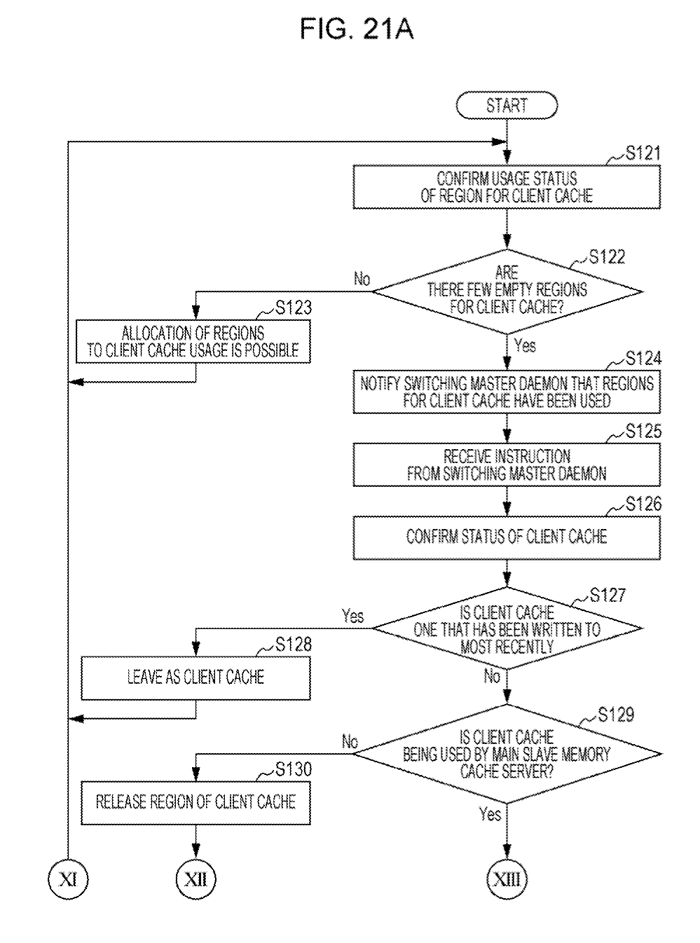

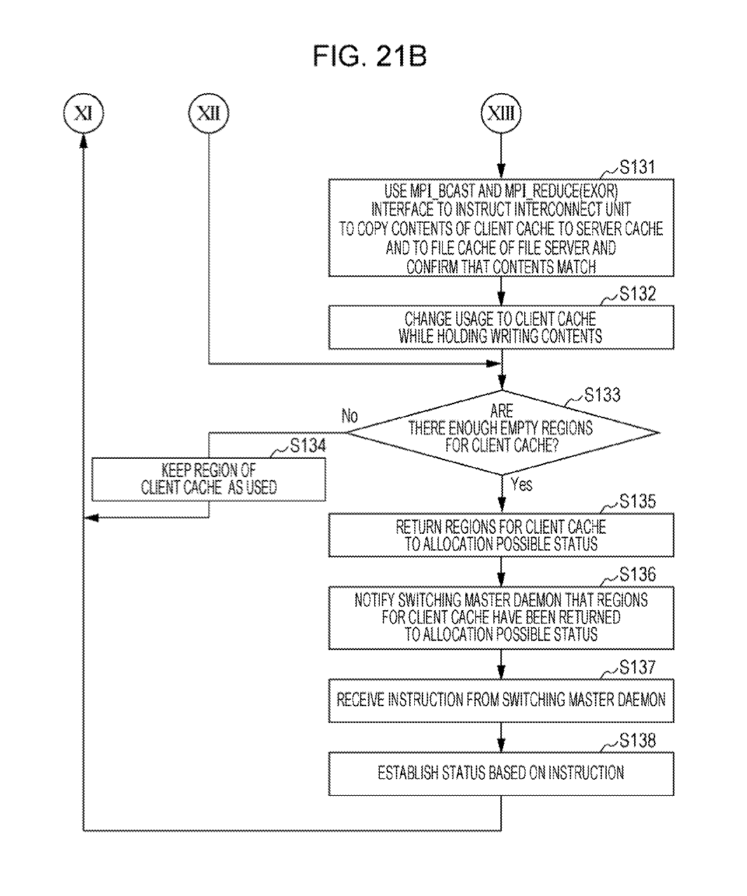

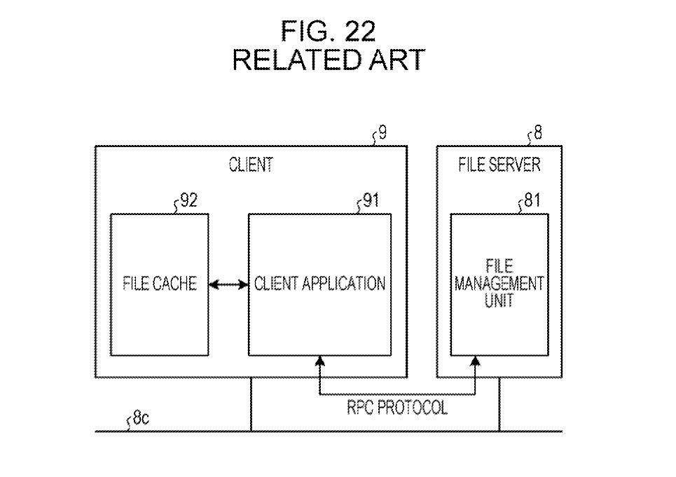

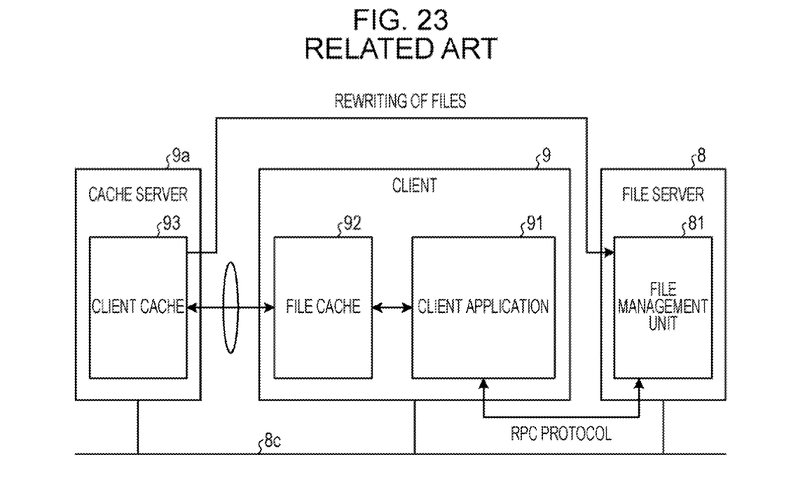

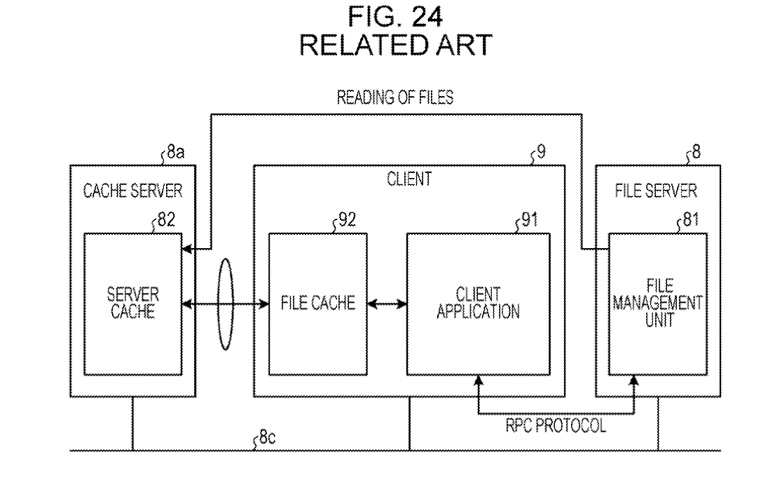

FIGS. 21A and 21B are flow charts illustrating a flow of switching processing of the switching sub-daemon 41 for controlling the switching of the server cache 40d based on a usage state of a region that can be used as the client cache 40c. As illustrated in FIG. 21, the switching sub-daemon 41 confirms the usage status of the region for the client cache 40c (step S121).

The switching sub-daemon 41 then determines whether there is a state of few empty regions for the client cache 40c (step S122). The state of there being few empty regions for the client cache 40c is the state of, for example, 80% or more of the regions for the client cache 40c being used. If there is no state of there being few empty regions for the client cache 40c, the switching sub-daemon 41 is able to allocate the region for the client cache 40c (step S123), and the processing returns to step S121.

However, if there is a state of there being few empty regions for the client cache 40c, the switching sub-daemon 41 notifies the switching master daemon 32 that the regions for the client cache 40c have been used (step S124). The switching sub-daemon 41 then waits for an instruction from the switching master daemon 32 and receives the instruction from the switching master daemon 32 (step S125).

The switching sub-daemon 41 confirms the status of the client cache 40c (step S126) and determines whether the client cache 40c is the one that has been written to most recently (step S127). If the client cache 40c is the one that has been written to most recently, the switching sub-daemon 41 leaves the client cache 40c that has been used as the client cache 40c (step S128), and the processing returns to step S121.

However, if the client cache 40c is not the one that has been written to most recently, the switching sub-daemon 41 then determines whether the client cache 40c is being used by the main slave memory cache server 4 (step S129). If the client cache 40c is not being used by the main slave memory cache server 4 as a result thereof, the switching sub-daemon 41 releases the region of the client cache 40c (step S130), and the processing advances to step S133.

However, if the client cache 40c is being used by the main slave memory cache server 4, the switching sub-daemon 41 uses the MPI_BCAST and MPI_REDUCE (EXOR) interface to execute the following processing. Namely, the switching sub-daemon 41 instructs the interconnect unit 10c to copy the contents of the client cache 40c to the server cache 40d and to the file cache of the file server 2 and to confirm that the contents match (step S131). The switching sub-daemon 41 then changes the usage of the server cache 40d while holding the writing contents of the client cache 40c that have been used (step S132).

The switching master daemon 32 then determines whether there are enough empty regions for the client cache 40c (step S133). The state of there being enough empty regions for the client cache 40c is the state of, for example, less than 60% of the regions for the client caches 40c being used. If there is no state of there being enough empty regions for the client cache 40c, the switching sub-daemon 41 keeps the region of the client cache 40c as used (step S134), and the processing returns to step S121.

However, if there is a state of there being enough empty regions for the client cache 40c, the switching sub-daemon 41 returns the regions for the client cache 40c to an allocation possible status (step S135). The switching sub-daemon 41 then notifies the switching master daemon 32 that the regions of the client cache 40c have been returned to the allocation possible status (step S136).

The switching sub-daemon 41 then waits for an instruction from the switching master daemon 32 and receives the instruction from the switching master daemon 32 (step S137), and establishes the status based on the instruction (step S138). The status based on the instruction includes the status for changing from the client cache 40c to the server cache 40d or the status for stopping the changing from the client cache 40c to the server cache 40d.

In this way, the switching from the client cache 40c to the server cache 40d is controlled based on the status of the empty regions for the client cache 40c, whereby switching suited to the status of the empty regions for the client cache 40c can be performed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A parallel processing device having a plurality of nodes, wherein the device comprises:
a first node having:
a first memory; and
a processor coupled to the first memory and configured to execute a first process, the first process comprising;
storing first data in the first memory;
transmitting the first data to other nodes; and
switching an use of the first data from a client cache to a server cache;
a second node having:
a second memory, and
a second processor coupled to the second memory and configured to execute a second process, the second process comprising;
storing the first data in the second memory that is slower than the first memory;
recording data management information which indicates that the first data is being stored by the first node in the first memory;
receiving a transmission request of the first, data from a third node; and
referring to the data management information, when the transmission request is received, and instructing the first node to transmit the first data to the third node, if the use of the first data is switched to the server cache, and if the first data is stored in the first memory of the first node.

2. The parallel processing device according to claim 1, wherein in the transmitting, the first data is transmitted to the second node by remote direct memory access (RDMA) transfer using a group communication interface of a message passing interface (MPI)

3. The parallel processing device according to claim 2, wherein in the transmitting, a matching between the first data in the first node and the first data in the second node is confirmed by using an exclusive OR operation of a MPI REDUCE interface.

4. The parallel processing device according to claim 3, wherein in the switching, the use of the first data is switched to the server cache when the matching of the first data is confirmed.

5. The parallel processing device according to claim 3, wherein in the switching, the use of the first data is switched to the server cache when an allocation of an available region for a client cache allocated to the first node becomes less than a predetermined threshold.

6. A memory cache control method, wherein:
a first node stores first data as a client cache in a first storage device and switches an use of the stored first data to a server cache; and
a second node:
stores the first data in a second storage device which is slower than the first storage device;
records data management information which indicates that the first data is being stored by in the first storage device of the first node; and
when a transmission request of the first data is received from a third node, refers to the data management information, and when the first data is stored in the first storage device of the first node and when the first data is switched to the server cache, instructs the first node to transmit the first data to the third node.
